(19) United States
(12) Patent Application Publication
(10) Pub. No.: US 2018/0204157 A1
(43) Pub. Date: Jul. 19, 2018

(54) SYSTEMS AND METHODS FOR ALLOCATING APPOINTMENT ORDERS

(71) Applicant: BEIJING DIDI INFINITY TECHNOLOGY AND DEVELOPMENT CO., LTD., Beijing (CN)

(72) Inventors: Junqin LI, Beijing (CN); Yanjun LU, Beijing (CN)

(73) Assignee: BEIJING DIDI INFINITY TECHNOLOGY AND DEVELOPMENT CO., LTD., Beijing (CN)

(21) Appl. No.: 15/566,443

(22) PCT Filed: Apr. 5, 2017
(86) PCT No.: PCT/CN2017/079433

§ 371 Date: Oct. 13, 2017

(30) Foreign Application Priority Data
Jun. 6, 2016 (CN) 201610401942.X
Jun. 14, 2016 (CN) 201610436566.8

(51) Int. Cl. G06Q 10/06; G06Q 50/30; G08G 1/00

(52) U.S. Cl. CPC G06Q 10/06311; G08G 1/202; G06Q 50/30

(57) ABSTRACT

A system includes at least one computer-readable storage medium including a set of instructions for providing an on-demand service; and at least one processor in communication with the computer-readable storage medium to execute the set of instructions to: obtain an appointment request of an on-demand service from a requester; determine a first service provider terminal set based on a first criterion; send an appointment invitation of the appointment request to the first service provider terminal set; obtain at least one response to accept the appointment invitation from a second service provider terminal set in the first service provider terminal set; determine a target service provider terminal from the second service provider terminal set based on a second criterion; establish a contractual relationship between the requester and the target service provider terminal; and send a confirmation notification of the appointment request to the target service provider terminal and the requester.

### CROSS-REFERENCE TO RELATED APPLICATIONS

This application claims priority to Chinese Application No. 201610401942.X filed on Jun. 6, 2016, Chinese Application No. 201610436566.8, filed on Jun. 14, 2016, the contents of which are incorporated herein in their entirety by reference.

### TECHNICAL FIELD

The present disclosure generally relates to systems and methods for on-demand service, and in particular, systems and methods for allocating appointment orders.

### BACKGROUND

On-demand transportation service, such as taxi services, has become more and more popular. When a server of an online transportation service platform receives an appointment request (e.g., a taxi service request) from a requester via a requester terminal, the server will broadcast an appointment invitation to a plurality of service provider terminals. A service provider, such as a driver, who receives the appointment invitation through a provider terminal and wishes to accept the invitation generally may have to quickly make a response to the appointment invitation, and the server may have to allocate the appointment order of the appointment request immediately. Therefore, a problem of making an on-demand service appointment is that the user experience is bad for both the request and the service provider. Accordingly, it is desirable to provide systems and methods for allocating appointment orders effectively.

### SUMMARY

According to exemplary embodiments of the present disclosure, a system may include at least one computer-readable storage medium including a set of instructions for providing an on-demand service; and at least one processor in communication with the computer-readable storage medium, wherein when executing the set of instructions, the at least one processor is directed to: obtain an appointment request of an on-demand service from a requester; determine a first service provider terminal set based on a first criterion; send an appointment invitation of the appointment request to the first service provider terminal set; obtain at least one response to accept the appointment invitation from a second service provider terminal set in the first service provider terminal set; determine a target service provider terminal from the second service provider terminal set based on a second criterion; establish a contractual relationship between the requester and a user of the target service provider terminal; and send a confirmation notification of the appointment request to the target service provider terminal and the requester.

According to exemplary embodiments of the present disclosure, wherein the appointment request includes a starting location of the on-demand service and a starting time of the on-demand service; and the first criterion includes at least one of: an evaluation value of a service provider terminal is greater than an evaluation threshold, or a distance between a home location of the user of a service provider terminal and the starting location of the on-demand service is less than a distance threshold.

According to exemplary embodiments of the present disclosure; when determining of the first service provider terminal set, wherein the at least one processor is further directed to: obtain a plurality of service provider terminals; for each service provider terminal of the plurality of service provider terminals: assign a first weight factor to the evaluation value of a service provider terminal; assign a second weight factor to the distance; determine a first total value of the provider terminal based on the first weight factor and the second weight factor; and select, from the plurality service provider terminals; at least one service provider terminal that the corresponding first total value is higher than a total threshold value as the first provider terminal set.

According to exemplary embodiments of the present disclosure, wherein the appointment request includes a starting location of the on-demand service and a starting time of the on-demand service; and the second criterion includes at least one of: an evaluation value of a service provider terminal is the greatest value of the second service provider terminal set, a distance between a location of the user of a service provider terminal and the starting location of the on-demand service is the least value of the second service provider terminal set, or an amount of successful orders of a service provider terminal in is the greatest value of the second service provider terminal set.

According to exemplary embodiments of the present disclosure; when determining the target service provider terminal, wherein the at least one processor is further directed to: for each service provider terminal of the second service provider terminal set: assign a third weight factor to the evaluation value of a service provider terminal; assign a fourth weight factor to the distance; assign a fifth weight factor to the amount of the successful orders; determine a second total value of the provider terminal based on the third weight factor, the fourth weight factor and the fifth weight factor; and select; from the second service provider terminal set, a service provider terminal that the corresponding second total value is the highest as the target service provider terminal.

According to exemplary embodiments of the present disclosure; wherein the appointment request includes a starting location of the on-demand service and a starting time of the on-demand service; and the at least one processor is further directed to: determine a time period before the starting time of the on-demand service after obtaining the appointment request of an the on-demand service from the requester to send out the appointment invitation of the appointment request.

According to exemplary embodiments of the present disclosure, the at least one processor is further directed to; broadcast the appointment invitation to the first service provider terminal set, or unicast the appointment invitation to an individual service provider terminal in the first service provider terminal set.

According to exemplary embodiments of the present disclosure, a method includes obtaining, by at least one computer server, an appointment request of an on-demand service from a requester; determining, by the at least one computer server, a first service provider terminal set based on a first criterion; sending, by the at least one computer server, an appointment invitation of the appointment request to the first service provider terminal set; obtaining, by the at least one computer server, at least one response to accept the appointment invitation from a second service provider terminal set in the first service provider terminal set; determining, by the at least one computer server, a target service provider terminal from the second service provider terminal set based on a second criterion; establishing, by the at least one computer server, a contractual relationship between the requester and a user of the target service provider terminal; and sending, by the at least one computer server, a confirmation notification of the appointment request to the target service provider terminal and the requester.

According to exemplary embodiments of the present disclosure, wherein the appointment request includes a starting location of the on-demand service and a starting time of the on-demand service; and the first criterion includes at least one of; an evaluation value of a service provider terminal is greater than an evaluation threshold, or a distance between a home location of the user of a service provider terminal and the starting location of the on-demand service is less than a distance threshold.

According to exemplary embodiments of the present disclosure, wherein the determining of the first service provider terminal set includes: obtaining a plurality of service provider terminals; for each service provider terminal of the plurality of service provider terminals: assigning a first weight factor to the evaluation value of a service provider terminal; assigning a second weight factor to the distance; determining a first total value of the provider terminal based on the first weight factor and the second weight factor; and selecting, from the plurality service provider terminals, at least one service provider terminal that the corresponding first total value is higher than a threshold value as the first provider terminal set.

According to exemplary embodiments of the present disclosure, wherein the appointment request includes a starting location of the on-demand service and a starting time of the on-demand service; and the second criterion includes at least one of: an evaluation value of a service provider terminal is the greatest value of the second service provider terminal set, a distance between a location of the user of a service provider terminal and the starting location of the on-demand service is the least value of the second service provider terminal set, or an amount of successful orders of a service provider terminal in is the greatest value of the second service provider terminal set.

According to exemplary embodiments of the present disclosure, wherein the determining of the target service provider terminal includes: for each service provider terminal of the second service provider terminal set: assigning a third weight factor to the evaluation value of a service provider terminal; assigning a fourth weight factor to the distance; assigning a fifth weight factor to the amount of the successful orders; determining a second total value of the provider terminal based on the third weight factor, the fourth weight factor and the fifth weight factor; and selecting, from the second service provider terminal set, a service provider terminal that the corresponding second total value is the highest as the target service provider terminal.

According to exemplary embodiments of the present disclosure; wherein the appointment request includes a starting location of the on-demand service and a starting time of the on-demand service; and the method further comprising: determining, by the at least one computer server, a time period before the starting time of the on-demand service after obtaining the appointment request of an the on-demand service from the requester to send out the appointment invitation of the appointment request.

According to exemplary embodiments of the present disclosure, wherein the sending of the appointment invitation of the appointment request to the first service provider terminal set includes at least one of: broadcasting the appointment invitation to the first service provider terminal set, or unicasting the appointment invitation to an individual service provider terminal in the first service provider terminal set.

According to exemplary embodiments of the present disclosure, A non-transitory computer readable medium, comprising at least one set of instructions for providing an on-demand service wherein when executed by a processor of a computer server, the at least one set of instructions directs the processor to perform acts of obtaining, by at least one computer server, an appointment request of an on-demand service from a requester; determining, by the at least one computer server, a first service provider terminal set based on a first criterion; sending, by the at least one computer server; an appointment invitation of the appointment request to the first service provider terminal set; obtaining, by the at least one computer server, at least one response to accept the appointment invitation from a second service provider terminal set in the first service provider terminal set; determining, by the at least one computer server, a target service provider terminal from the second service provider terminal set based on a second criterion; establishing, by the at least one computer server, a contractual relationship between the requester and a user of the target service provider terminal; and sending, by the at least one computer server, a confirmation notification of the appointment request to the target service provider terminal and the requester.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1 is a block diagram of an exemplary on-demand service system according to some embodiments;

FIG. 2 is a schematic diagram illustrating exemplary hardware and software components of a computing device according to some embodiments;

FIG. 3 is a block diagram illustrating an exemplary processing engine according to some embodiments;

FIG. 4 is a flowchart of an exemplary process for allocating an appointment order according to some embodiments;

FIG. 5 is a flowchart of an exemplary process for determining a first driver terminal set according to some embodiments;

FIG. 6 is a flowchart of an exemplary process for determining a first driver terminal set according to some embodiments;

FIG. 7 is a flowchart of an exemplary process for determining a first driver terminal set according to some embodiments;

FIG. 8 is a flowchart of an exemplary process for determining a target driver terminal based on a second criterion according to some embodiments;

FIG. 9 is a flowchart of an exemplary process for determining a target driver terminal based on a second criterion according to some embodiments;

FIG. 10 is a flowchart of an exemplary process for determining a target driver terminal based on a second criterion according to some embodiments; and

FIG. 11 is a flowchart of an exemplary process for determining a terminal based on a second criterion according to some embodiments.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may or may not be implemented in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to scheduling vehicles, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “request” in the present disclosure refers to a request that may be initiated by a passenger, a requester, a service requester, a customer, a driver, a provider, a service provider, a supplier, or the like, or any combination thereof. The request may be accepted by any one of a passenger, a requester, a service requester, a customer, a driver, a provider, a service provider, or a supplier. The request may be chargeable, or free. The term “order” in the present disclosure refers to an intention that both a passenger (or a requester, a service requester, a customer, etc.) and a driver (or a provider, a service provider, or a supplier, etc.) show agreement of the request.

The position and/or the travel starting point in the present disclosure may be acquired by positioning technology embedded in the passenger terminal. The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to online systems and methods for appointing an on-demand service before the service begins, such as appointing a vehicle. According to the present disclosure, the systems and methods may require two choices to determine a target service provider terminal for allocating an appointment order. The systems and methods may require a judgement of a distance between a home location of a user of a service provider terminal and a starting location of an appointment request for allocating an appointment order.

It should be noted that online on-demand transportation service, such as online taxi hailing, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Online taxi, however, allows a user of the service to reserve a service and automatic distribute the reservation service request to a vast number of individual service providers (e.g., taxi) distance away from the user. It also allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system. Allocating appointment orders provides an efficient service for both requesters and service provides.

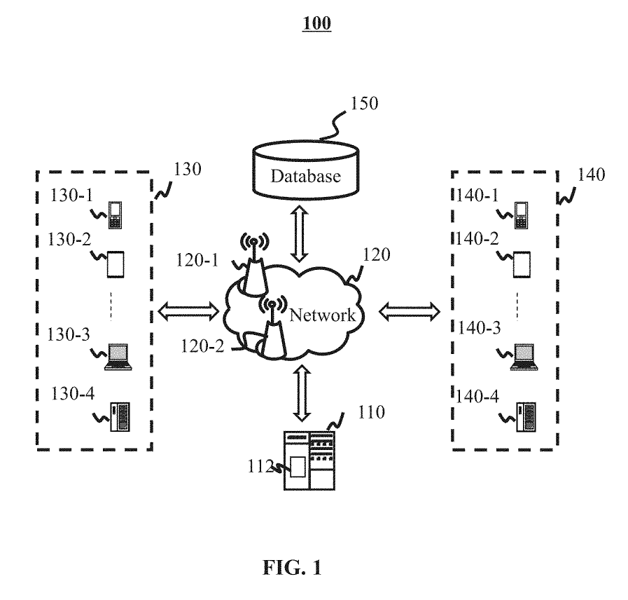

FIG. 1 is a block diagram of an exemplary on-demand service system 100 according to some embodiments. For example, the on-demand service system 100 may be an online transportation service platform for transportation services such as taxi hailing, chauffeur service, express car, carpool, bus service, driver hire and shuttle service. The on-demand service system 100 may include a server 110, a network 120, a passenger terminal 130, a driver terminal 140, and a database 150. The server 110 may include a processing engine 112.

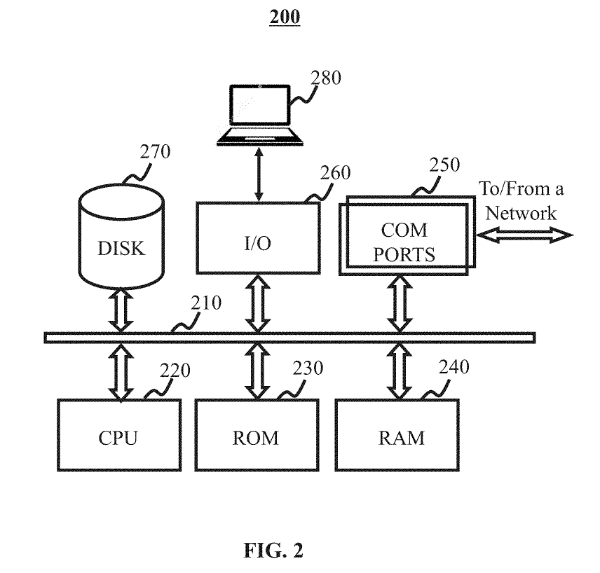

The server 110 may be configured to process information and/or data relating to a service request. For example, the server 110 may receive a service request from a passenger terminal 130, and process the request to assign a driver terminal 140 to provide service for the user of the passenger terminal 130. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in passenger terminal 130, driver terminal 140, and/or database 150 via network 120. As another example, the server 110 may be directly connected to the passenger terminal 130, the driver terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may receive a service request of the service from the passenger terminal 130, and/or allocate a service order to the driver terminal 140. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the passenger terminal 130, the driver terminal 140, and the database 150) may send and/or receive information and/or data to/from other component(s) in the system 100 via the network 120. For example, the server 110 may obtain/acquire service request from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the system 100 may be connected to the network 120 to exchange data and/or information.

The passenger terminal 130 may be used by a passenger to request an on-demand service. For example, a user of the passenger terminal 130 may use the passenger terminal 130 to send a service request for himself/herself or another user, or receive service and/or information or instructions from the server 110. In some embodiments, the term “user” and “passenger terminal” may be used interchangeably.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (FOS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. Merely by way of example, the passenger terminal 130 may include a controller (e.g., a remote-controller).

In some embodiments, the passenger terminal 130 may be a device with positioning technology for locating the position of the user and/or the passenger terminal 130. In some embodiments, the passenger terminal 130 may communicate with other positioning device to determine the position of the user, and/or the passenger terminal 130. In some embodiments, the passenger terminal 130 may send positioning information to the server 110.

The driver terminal 140 may be used by a driver to communicate with the server 100 and the passenger terminal 130. In some embodiments, the driver terminal 140 may be a terminal that manage and/or control at least one vehicle. For example, the driver terminal 140 may be a platform that control several vehicles. In some embodiments, the driver terminal 140 may be similar to, or the same device as the passenger terminal 130.

The database 150 may store data and/or instructions. In some embodiments, the database 150 may store data obtained/acquired from the passenger terminal 130 and/or the driver terminal 140. In some embodiments, the database 150 may store data and/or instructions that the server 110 may execute or use to perform exemplary methods described in the present disclosure. In some embodiments, the database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the system 100 (e.g., the server 110, the passenger terminal 130, the driver terminal 140, etc.). One or more components in the system 100 may access the data or instructions stored in the database 150 via the network 120. In some embodiments, the database 150 may be directly connected to or communicate with one or more components in the system 100 (e.g., the server 110, the passenger terminal 130, the driver terminal 140, etc.). In some embodiments, the database 150 may be part of the server 110.

In some embodiments, one or more components in the system 100 (e.g., the server 110, the passenger terminal 130, the driver terminal 140, etc.) may have a permission to access the database 150. In some embodiments, one or more components in the system 100 may read and/or modify information related to the passenger, driver, and/or the public when one or more conditions are met. For example, the server 110 may read and/or modify one or more users' information after a service. As another example, the driver terminal 140 may access information related to the passenger when receiving a service request from the passenger terminal 130, but the driver terminal 140 may not modify the relevant information of the passenger.

In some embodiments, information exchanging of one or more components in the system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the passenger terminal 130, and/or the driver terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an on-demand system for the present disclosure. The computing device 200 may implement any component of the on-demand service as described herein. In FIGS. 1-2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

Merely for illustration, only one CPU/processor 220 is described in the computing device 200. However, it should be note that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

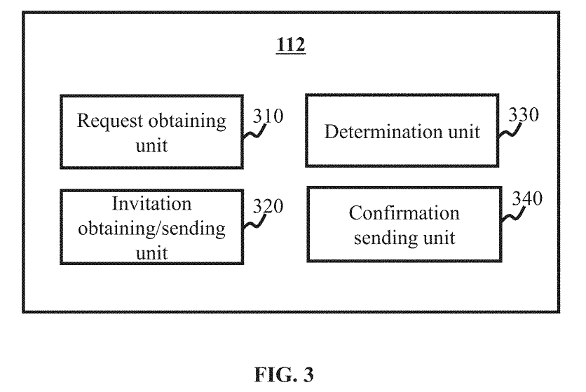

FIG. 3 is a block diagram illustrating an exemplary processing engine 112 according to some embodiments. The processing engine 112 may include a request obtaining unit 310, an invitation obtaining/sending unit 320, a determination unit 330, and a confirmation sending unit 340.

The request obtaining unit 310 may be configured to obtain a request from the passenger terminal 130. For example, the request obtaining unit 310 may obtain an appointment request and/or a real-time request of taxi hailing, chauffeur service, drive hire, express car, carpool, bus service, or shuttle service.

The invitation obtaining/sending unit 320 may be configured to send an invitation to a driver terminal 140, and/or obtain a response to an invitation from a driver terminal 140. For example, the invitation obtaining/sending unit 320 may send an invitation to a driver terminal 140 to provide an on-demand service for a passenger terminal 130. As another example, the invitation obtaining/sending unit 320 may obtain a response to accepting an invitation from a driver terminal 140.

The determination unit 330 may be configured to determine one or more driver terminals based on one or more criterions. For example, the determination unit 330 may determine a first driver terminal set based on a first criterion. As another example, the determination unit 330 may determine a target driver terminal based on a second criterion.

The confirmation sending unit 340 may be configured to send a confirmation notification of an on-demand service order to a driver terminal 140 and/or a passenger terminal 130. For example, the confirmation sending unit 340 may send a failure notification of an on-demand service order to a driver terminal 140 and/or a passenger terminal 130.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the request obtaining unit 310 may be integrated in the invitation obtaining/sending unit 320 as a single module which may both obtain features of orders and determine matching information of the orders.

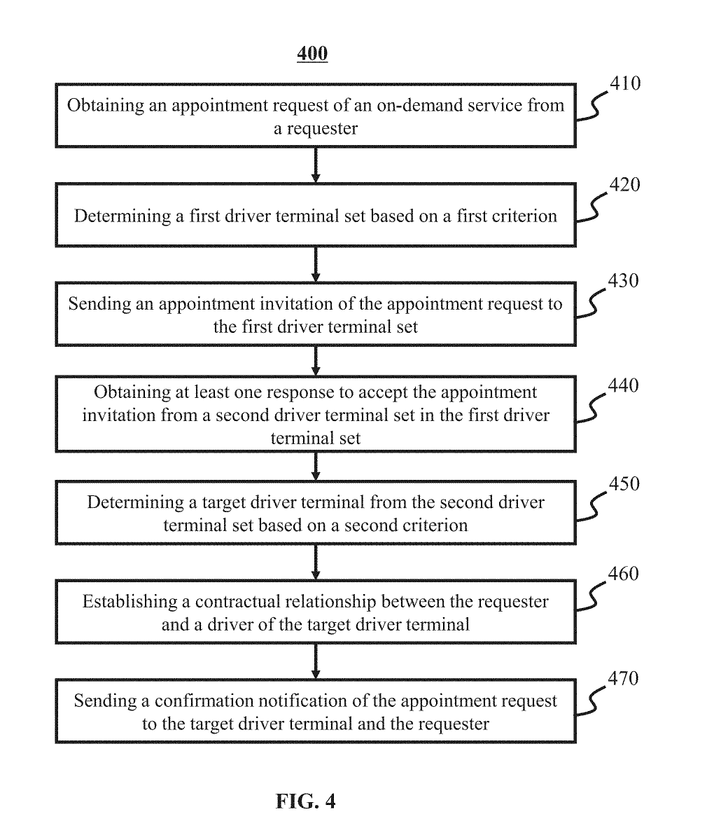

FIG. 4 is a flowchart of an exemplary process 400 for allocating an appointment order according to some embodiments. In some embodiments, the process 400 may be implemented in the system 100 illustrated in FIG. 1. For example, the process 400 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more components in the processing engine 112 illustrated in FIG. 3).

In step 410, the processor 220 may obtain/acquire an appointment request of an on-demand service from a requester. In some embodiments, the processor 220 may obtain the appointment request via the network 120. In some embodiments, the requester may be a user of a passenger terminal. The on-demand service may be a taxi service, a test driving service, a goods delivery service or the like, or a combination thereof. The appointment request may request the on-demand service to be serviced at a specific time that does not need a service provider to immediately depart towards the service requester. In some embodiments, the appointment request may include a starting location of the on-demand service, a starting time of the on-demand service, a destination, or the like, or any combination thereof. For example, the appointment request may be a request for online taxi hailing, the starting location is Street 1, the starting time is 10:00 am, and the destination is Street 2.

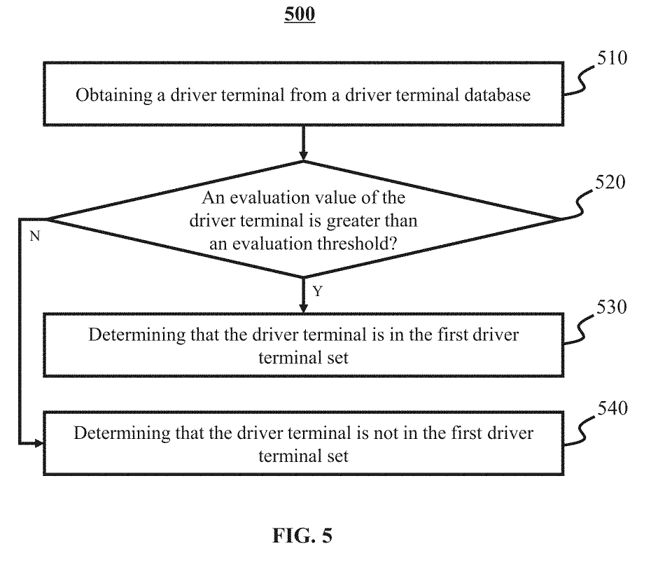

In step 420, the processor 220 may determine a first driver terminal set based on a first criterion. For example, the processor 220 may select, from a plurality of drivers in a driver database of the system 100, a set of drivers whose home is within a predetermined distance away from the starting location of the requested service, and each driver may use a driver terminal to communicate with the system 100. In some embodiments, the first driver terminal set may include at least one driver terminal associated with at least one driver. The first criterion may be an evaluation value criterion and/or a distance criterion. The evaluation value criterion may require that an evaluation value of a driver terminal is greater than an evaluation threshold, wherein the evaluation threshold may be a default value set by the processor 220, or may be a value determined by the service requester and received by the processor 220. The distance criterion may require that a distance between the home location of a user of driver terminal and a starting location of the appointment request is less than a distance threshold, wherein the distance threshold may be a default value set by the processor 220, or may be a value determined by the service requester and received by the processor 220. In some embodiments, the first criterion may include both the evaluation value criterion and the distance criterion. In some embodiments, the processor 220 may assign the evaluation value of a driver terminal and the distance between the home location of a user of driver terminal and a starting location in the first criterion with a first weight factor and a second weight factor. For example, the processor 220 may assign the first weight factor of 75% to the evaluation value criterion that the evaluation value is greater than the evaluation threshold, and assign the second weight factor of 25% to the distance criterion that the distance is less than the distance threshold. In some embodiments, the processor 220 may determine the first driver terminal set by performing one or more operations described in conjunction with FIGS. 5-7 below.

In step 430, the processor 220 may send an appointment invitation of the appointment request to the first driver terminal set. In some embodiments, the appointment invitation may include an identifier of the passenger terminal, the starting location of the on-demand service, the starting time of the on-demand service, the destination of the on-demand service, an estimated value of the time that the on-demand service may take, an estimated cost and/or price of the on-demand service, or the like, or any combination thereof. In some embodiments, the driver terminal may communicate with the online on-demand service platform 100 via an application installed in the driver terminal. Accordingly, the driver terminal may display the appointment invitation via a user interface of the application. The service provider (e.g., the driver) may accept the appointment invitation through the user interface. Alternatively, the processor 220 may send the appointment invitation as a cellphone message, an e-mail, a pop-up message from a social network service, or the like, or any combination thereof. In some embodiments, the processor 220 may generally broadcast the appointment invitation to the first driver terminal set, i.e., the processor 220 may set and/or identify a common identity for all members of driver terminals in the first set, and send the appointment invitation to the members of the first driver terminal set altogether according to the common identity. In some embodiments, the processor 220 may unicast the appointment invitation to an individual driver terminal in the first driver terminal set. To this end, the processor 220 may unicasting the appointment invitation by sending the appointment invitation to an individual driver terminal in the first driver terminal set according to their respective identities. For example, the processor 220 may unicast the appointment invitation to a first individual driver terminal in the first driver terminal set. If the first individual driver terminal does not response to the processor 220, the processor 220 may unicast the appointment invitation to a second individual driver terminal in the first driver terminal set. The processor 220 may keep unicasting the appointment invitation to one or a predetermined number of driver terminal(s) in the first driver terminal set one by one until one of the individual driver terminals accepts the appointment invitation. In some embodiments, the processor 220 may generally broadcast or unicast the appointment invitation to at least one driver terminal in the first driver terminal set based on at least one criterion described in the present disclosure.

In step 440, the processor 220 may obtain and/or receive at least one response to accept the appointment invitation from a second driver terminal set in the first driver terminal set. For example, some drivers (i.e., a second set of drivers that corresponds to the second set of driver terminals) may accept the appointment invitation through the user interface. In some embodiments, the response to accept the appointment invitation may also be obtained as a reply cellphone message, a reply e-mail, a reply to the pop-up message, or the like, or any combination thereof.

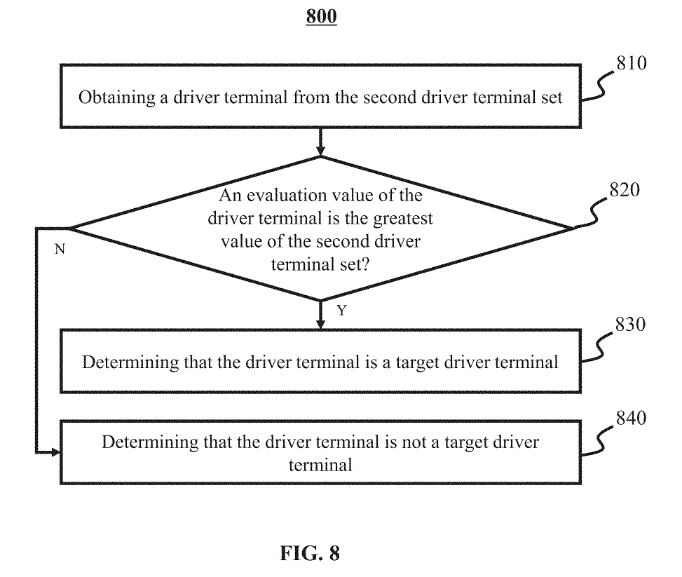

In step 450, the processor 220 may determine a target driver terminal from the second driver terminal set based on a second criterion. In some embodiments, the second criterion may include that an evaluation value of a service provider terminal is the greatest value of the second service provider terminal set, a distance between a location of the user of a service provider terminal and the starting location of the on-demand service is the least value of the second service provider terminal set, an amount of successful orders of a service provider terminal in the greatest value of the second service provider terminal set, or the like, or any combination thereof. For example, the second criterion may include that the evaluation value of the service provider terminal is the greatest value of the second service provider terminal set and that the distance between the location of the user of the service provider terminal and the starting location of the on-demand service is the least value of the second service provider terminal set. As another example, the second criterion may include that the evaluation value of the service provider terminal is the greatest value of the second service provider terminal set and that the amount of successful orders of the service provider terminal in the greatest value of the second service provider terminal set. As still another example, the second criterion may include that the distance between the location of the user of the service provider terminal and the starting location of the on-demand service is the least value of the second service provider terminal set and that the amount of successful orders of the service provider terminal in the greatest value of the second service provider terminal set. As still another example, the second criterion may include the evaluation value of the service provider terminal is the greatest value of the second service provider terminal set, the distance between the location of the user of the service provider terminal and the starting location of the on-demand service is the least value of the second service provider terminal set, and the amount of successful orders of the service provider terminal in the greatest value of the second service provider terminal set. The second criterion may be different from the first criterion. For example, if the first set of driver terminals is selected based on distance of a driver's home and the starting location of the request, then the second criterion may be something different, such as evaluation value of a driver corresponds to a driver terminal in the second set of driver terminals. In some embodiments, the processor 220 may determine the target driver terminal by performing one or more operations described in FIGS. 8-11 below.

In step 460, the processor 220 may establish a contractual relationship between the requester and a driver of the target driver terminal. In some embodiments, the contractual relationship between the requester and the driver of the target driver terminal may be implemented as an electronic contract. In some embodiments, the contractual relationship between the requester and the driver of the target driver terminal may be implemented by registering the on-demand service platform. In some embodiments, the processor 220 may make a pointer to the account of the requester and the account of the driver. For example, the pointer may point the requester and/or the driver to a contract. As another example, the pointer may point a contract to the requester and/or the driver.

In step 470, the processor 220 may send a confirmation notification of the appointment request to the target driver terminal and the requester. The processor 220 may send the confirmation right after and/or shortly after the contractual relationship is established. The processor may also send a reminder of the confirmation to the driver terminal afterwards. For example, the processor 220 may determine a departure time of the driver to fulfill the service request from the requester and send a reminder to the driver terminal at or before the departure time. In some embodiments, the confirmation notification of the appointment request to be sent to the requester may include an identifier of the target driver terminal. For example, the confirmation notification may include a license plate number of the vehicle, a name of the driver, a color of the vehicle, a vehicle model, a phone number of the driver, or the like, or any combination thereof. In some embodiments, the confirmation notification of the appointment request to be sent to the target driver terminal may include an identifier of the user of the passenger terminal, the starting location of the on-demand service, the starting time of the on-demand service, the destination of the on-demand service, an estimated value of the time the on-demand service may take, an estimated distance that the on-demand service may take, an estimated cost that the on-demand service mat take, or the like, or any combination thereof. In some embodiments, the confirmation notification of the appointment request may be sent by the processor 220 may send to the interface of the application in the driver terminal, and/or as a cellphone message, an e-mail, a pop-up message from a social network service, or the like, or any combination thereof, to the driver terminal.

In some embodiments, the processor 220 may determine a time period before the starting time of the on-demand service to send out the appointment invitation of the appointment request after step 410, For example, the time period may be a period from 20 minutes to 90 minutes before the starting time of the on-demand service. The processor 220 may send out the appointment invitation to a plurality of driver terminals before 20 minutes to 90 minutes of the starting time of the on-demand service. In some embodiments, the processor 220 may determine the time period based on the distance between the driver and the requester, and/or the distance between the home of the driver and the requester. For example, if the home distance between the driver and the requester, based on the traffic at the time when the message is sent, needs 10 minutes' drive, the processor 220 may determine the time period to be 10 minutes plus a predetermined preparation time, such as another 20 minutes for the driver to get ready to drive to the requester. Therefore, the processor 220 may send the appointment invitation to the driver 30 minutes before the starting time.

FIG. 5 is a flowchart of an exemplary process 500 for determining a first driver terminal set according to some embodiments. In some embodiments, the process 500 may be implemented in the system 100 illustrated in FIG. 1. For example, the process 500 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more components in the processing engine 112 illustrated in FIG. 3).

In step 510, the processor 220 may obtain a driver terminal from a driver terminal database. In some embodiments, the driver terminal database may be stored in the database 150. In some embodiments, the driver terminal database may include a user name of the driver terminal, a vehicle associated with the driver terminal, a contact of the user of the driver terminal, a photo of the user of the driver terminal, an evaluation value of the driver terminal, a home location of the user of the driver terminal, or the like, or any combination thereof.

In step 520, the processor 220 may determine whether an evaluation value of the driver terminal obtained in step 510 is greater than an evaluation threshold. The evaluation threshold may be a default value set by the processor 220, or may be a value determined by the service requester and received by the processor 220. In some embodiments, the evaluation value of the driver terminal may be an average or median evaluation value determined by all passengers that the driver terminal provides on—demand services to. In some embodiment, the evaluation value may be represented as a star level. For example, the evaluation value of the driver terminal may be three, four or five stars level. In some embodiment, the evaluation value may be represented as a numerical value. For example, the evaluation value of the driver terminal may be any number less than 10 (e.g., 3.5, 4.8, 5.0, 7.9, 9.8, etc.) As another example, the evaluation value of the driver terminal may be any number less than 100 (e.g., 20, 55, 67, 88, 98, etc.), In some embodiments, the evaluation threshold may be preset by the processor 220. For example, the evaluation threshold may be the average value of all of the driver terminals in the driver terminal database. In some embodiments, the evaluation threshold may be preset by the service requester that requests for the on-demand service and be attached in the appointment request. For example, when requesting for appointing an on-demand service, the requester may preset an evaluation threshold in the appointment request. In some embodiments, the evaluation threshold may be determined according to a scenario of the on-demand service.

In some embodiments, if the evaluation value of the driver terminal is greater than the evaluation threshold, in step 530, the processor 220 may determine that the driver terminal is in the first driver terminal set. In some embodiments, if the evaluation value of the driver terminal is not greater than the evaluation threshold, in step 540, the processor 220 may determine that the driver terminal is not in the first driver terminal set. In some embodiments, the driver terminal database may include at least one driver terminal and the processor 220 may loop step 510 to step 540 in FIG. 5 to determine whether other driver terminals in the driver terminal database are in the first driver terminal set.

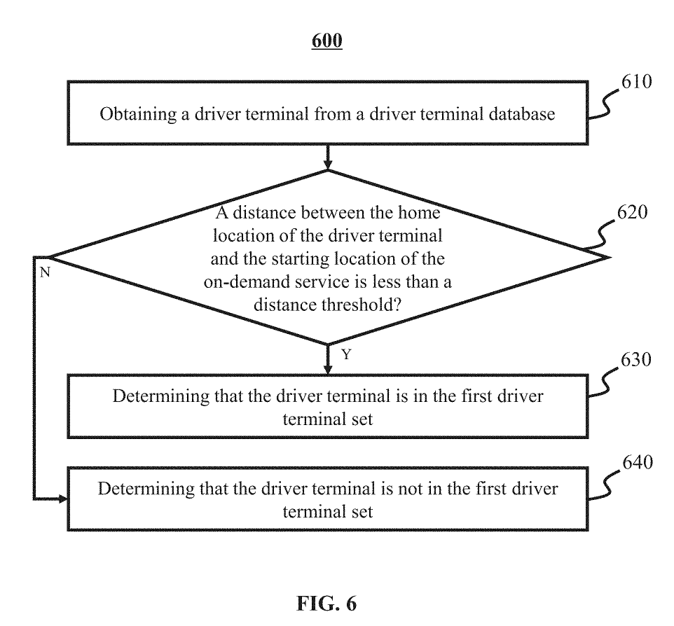

FIG. 6 is a flowchart of an exemplary process 600 for determining a first driver terminal set according to some embodiments. In some embodiments, the process 600 may be implemented in the system 100 illustrated in FIG. 1, For example, the process 600 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more components in the processing engine 112 illustrated in FIG. 3).

In step 610, the processor 220 may obtain a driver terminal from a driver terminal database. In some embodiments, the driver terminal database may be stored in the database 150. In some embodiments, the driver terminal database may include a user name of the driver terminal, a vehicle associated with the driver terminal, a contact of the user of the driver terminal, a photo of the user of the driver terminal, an evaluation value of the driver terminal, a home location of the user of the driver terminal, or the like, or any combination thereof.

In step 620, the processor 220 may determine whether a distance between the home location of the driver terminal obtained in step 610 and the starting location of the on-demand service is less than a distance threshold. The distance threshold may be a default value set by the processor 220, or may be a value determined by the service requester and received by the processor 220. In some embodiments, the distance between the home location of the driver terminal and the starting location of the on-demand service may be an estimated distance on the map. For example, the estimated distance on the map between the home location of the driver terminal and the starting location of the on-demand service may be the shortest distance, the least crowded distance, the optimal distance determined by the processor 220 based on the related historical information and/or real-time road conditions. In some embodiments, the distance threshold may be preset by the processor 220. For example, the distance threshold may be within a range of 1 kilometer to 5 kilometers, using the starting location as a center to form a circle, a square, a regular hexagon, or the like, or any combination thereof. In some embodiments, the distance threshold may be preset by the service requester that requests for the on-demand service and be attached in the appointment request. For example, when requesting for appointing an on-demand service, the requester may preset a distance threshold in the appointment request. In some embodiments, the distance threshold may be determined according to a scenario of the on-demand service.

In some embodiments, if the distance between the home location of the driver terminal and the starting location of the on-demand service is less than a distance threshold, in step 630, the processor 220 may determine that the driver terminal is in the first driver terminal set. In some embodiments, if the distance between the home location of the driver terminal and the starting location of the on-demand service is not less than a distance threshold, in step 640, the processor 220 may determine that the driver terminal is not in the first driver terminal set. In some embodiments, the driver terminal database may include at least one driver terminal and the processor 220 may loop step 610 to step 640 in FIG. 6 to determine whether other driver terminals in the driver terminal database are in the first driver terminal set.

In some embodiments, the processor 220 may determine whether a driver terminal is in the first driver terminal set based on both the process 500 and process 600 illustrated in FIG. 5 and FIG. 6. For example, the evaluation threshold is 4.8, and the distance threshold is 3 kilometers. The processor 220 may determine a driver terminal that meets the both conditions (e.g., the evaluation value is greater than 4.8 and the distance between the home location of the driver terminal and the starting location of the on-demand service is less than 3 kilometers) is in the first driver terminal.

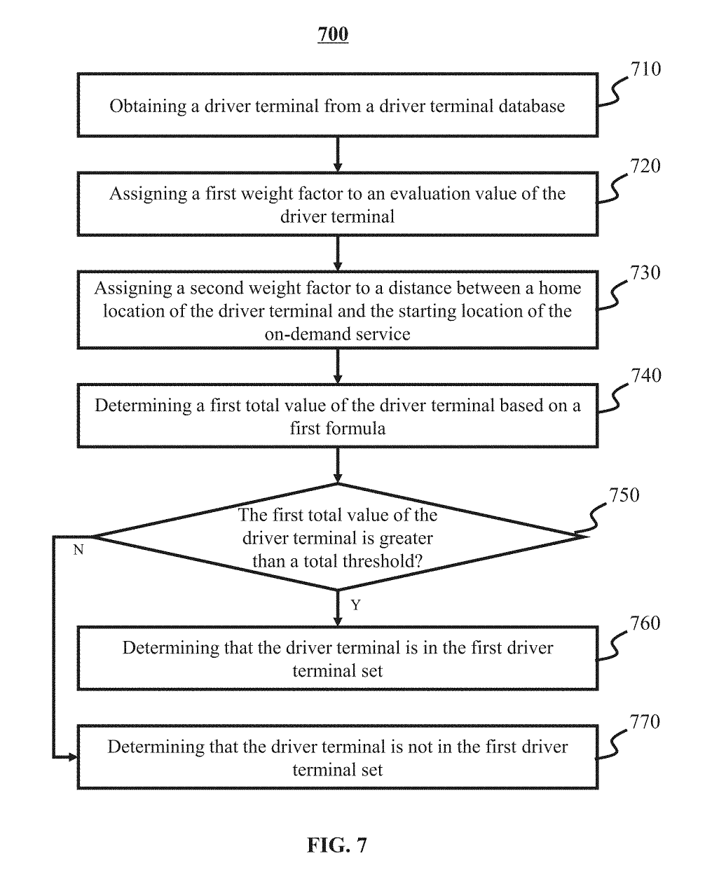

FIG. 7 is a flowchart of an exemplary process 700 for determining a first driver terminal set according to some embodiments. In some embodiments, the process 700 may be implemented in the system 100 illustrated in FIG. 1, For example, the process 700 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, or one or more components in the processing engine 112 illustrated in FIG. 3).

In step 710, the processor 220 may obtain a driver terminal from a driver terminal database. In some embodiments, the driver terminal database may be stored in the database 150. In some embodiments, the driver terminal database may include a user name of the driver terminal, a vehicle associated with the driver terminal, a contact of the user of the driver terminal, a photo of the user of the driver terminal, an evaluation value of the driver terminal, a home location of the user of the driver terminal, or the like, or any combination thereof.

In step 720, the processor 220 may assign a first weight factor to an evaluation value of the driver terminal. The first weight factor may be a default value set by the processor 220, or may be determined by the service requester and received by the processor 220. In some embodiments, the first weight factor may be any value within interval 0 to 1. For example, the first weight factor may be 0%, 10%, 25%, 50%, 80%, 100%, etc.

In step 730, the processor 220 may assign a second weight factor to a distance between the home location of the driver terminal and the starting location of the on-demand service. The second weight factor may be a default value set by the processor 220, or may be determined by the service requester and received by the processor 220, In some embodiments, the second weight factor may be any value within interval 0 to 1. For example, the second weight factor may be 100%, 90%, 75%, 50%, 20%, 0%, etc. The sum of the first weight factor and the second weight factor may be 1.

In step 740, the processor 220 may determine a first total value of the driver terminal based on a first formula. For example, the first total value may be represented as T₁, the first weight factor may be represented as X₁, the evaluation value of the driver terminal may be represented as E, the second weight factor may be represented as X₂, the distance between the home location of the driver terminal and the starting location of the on-demand service may be represented as D, the first formula may be:

T₁=X₁*E+X₂/D (1)

In step 750, the processor 220 may determine whether the first total value of the driver terminal is greater than a total threshold. In some embodiments, the total threshold may be preset by the processor 220. In some embodiments, the total threshold may be preset by the service requester that requests for the on-demand service and be attached in the appointment request. For example, when requesting for appointing an on-demand service, the requester may preset a total threshold in the appointment request and may be received by the processor 220. In some embodiments, the processor 220 may determine the total threshold according to a scenario of the on-demand service.

In some embodiments, if the first total value of the driver terminal is greater than a total threshold, in step 760, the processor 220 may determine that the driver terminal is in the first driver terminal set. In some embodiments, if the first total value of the driver terminal is not greater than a total threshold, in step 770, the processor 220 may determine that the driver terminal is not in the first driver terminal set. In some embodiments, the driver terminal database may include at least one driver terminal and the processor 220 may loop step 710 to step 770 in FIG. 7 to determine whether other driver terminals in the driver terminal database are in the first driver terminal set. In some embodiments, the higher the weight factor, the higher priority. For example, a driver terminal with a weight factor of 80% may have a higher priority than a driver terminal with a weight factor of 20%.

FIG. 8 is a flowchart of an exemplary process 800 for determining a target driver terminal based on a second criterion according to some embodiments. In some embodiments, the process 800 may be implemented in the system 100 illustrated in FIG. 1. For example, the process 800 may be stored in the database 150 and/or the storage (e.g., the ROM 230, the RAM 240, etc.) as a form of instructions, and called and executed by the server 110 (e.g., the processing engine 112 in the server 110, the CPU 220 of the processing engine 112 in the server 110, or one or more components in the processing engine 112 illustrated in FIG.

In step 810, the processor 220 may obtain a driver terminal from the second driver terminal set. The second driver terminal set may be stored in the database 150, the ROM 230, the RAM 240, and/or other type of non-transitory storage medium to be executed by the CPU 220. The second driver terminal set may be determined by the processor 220 from the first driver terminal set, and the second driver terminal set may include at least one driver terminal associated with at least one driver that sends a response to accept the appointment invitation in the first driver terminal set. In some embodiments, the driver terminal may include information about an evaluation value, a home location, an amount of successful orders, a historical order, or the like, or any combination thereof. In some embodiments, the processor 220 may loop steps 810-840 to obtain other driver terminals to be determined.

In step 820, the processor 220 may determine whether an evaluation value of the driver terminal is the greatest value of the second driver terminal set. In some embodiments, the evaluation value of the driver terminal may be an average or median evaluation value determined by all passengers that the driver terminal provides on—demand services to. In some embodiment, the evaluation value may be represented as a star level. For example, the evaluation value of the driver terminal may be three, four or five stars level. In some embodiment, the evaluation value may be represented as a numerical value. For example, the evaluation value of the driver terminal may be any number less than 10 (e.g., 3.5, 4.8, 5.0, 7.9, 9.8, etc.) As another example, the evaluation value of the driver terminal may be any number less than 100 (e.g., 20, 55, 67, 88, 98, etc.). In some embodiments, all evaluation values of the driver terminals of the second driver terminal set may be obtained. The driver terminal with the greatest evaluation value of the second driver terminal set may be determined. In some embodiments, there may be at least one driver terminal whose evaluation value is the greatest value of the second driver terminal set.

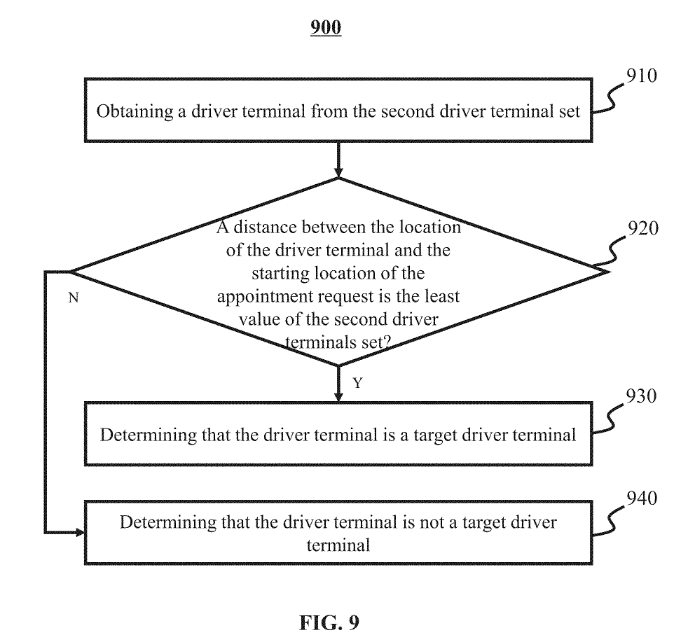

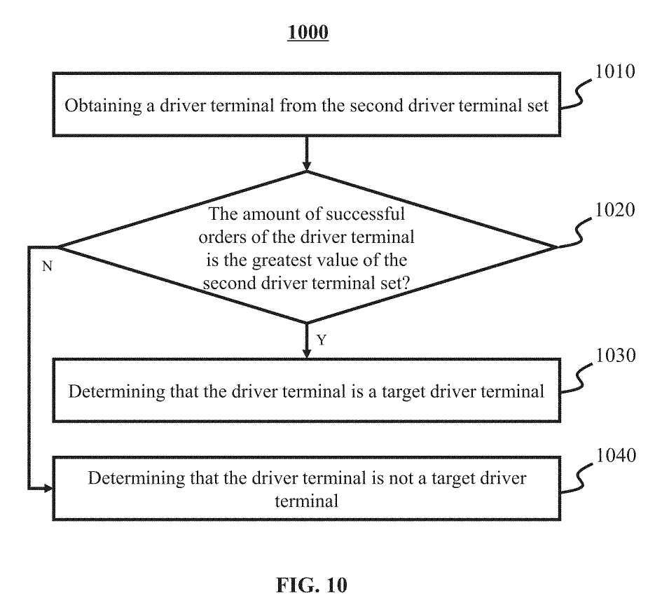

In step 830, if the evaluation value of the driver terminal is the greatest value of the second driver terminal set, the processor 220 may determine the driver terminal as a target driver. In some embodiments, there may be at least one driver terminal whose evaluation value is the greatest value of the second driver terminal set. In some embodiments, one of the at least one driver terminal may be determined as the target driver randomly. In some embodiments, one of the at least one driver terminal may be further determined as the target driver based other criteria (e.g., criteria illustrated in FIG. 9 or FIG. 10) described elsewhere in the present disclosure.

In step 840, if the evaluation value of the driver terminal isn't the greatest value of the second driver terminal set, the processor 220 may determine that the driver terminal is not a target driver terminal.

FIG. 9 is a flowchart of an exemplary process 900 for determining a target driver based on a second criterion according to some embodiments. In some embodiments, the process 900 may be implemented in the system 100 illustrated in FIG. 1. For example, the process 900 may be stored in the database 150 and/or the storage (e.g., the ROM 230, the RAM 240, etc.) as a form of instructions, and called and executed by the server 110 (e.g., the processing engine 112 in the server 110, the CPU 220 of the processing engine 112 in the server 110, or one or more components in the processing engine 112 illustrated in FIG. 3).

In step 910, the processor 220 may obtain a driver terminal from the second driver terminal set. The second driver terminal set may be stored in the database 150, the ROM 230, the RAM 240, and/or other type of non-transitory storage medium to be executed by the CPU 220. The second driver terminal set may be determined by the processor 220 from the first driver terminal set, and the second driver terminal set may include at least one driver terminal associated with at least one driver that sends a response to accept the appointment invitation in the first driver terminal set. In some embodiments, the driver terminal may include information about an evaluation value, a home location, an amount of successful orders, a historical order, or the like, or any combination thereof. In some embodiments, the processor 220 may loop steps 910-940 to obtain other driver terminals to be determined.

In step 920, the processor 220 may determine whether a distance between the home location of the driver terminal and the starting location of the appointment request is the least value of the second driver terminal set. In some embodiments, the distance between the home location of the driver terminal and the starting location of the on-demand service may be an estimated distance on the map. For example, the estimated distance on the map between the home location of the driver terminal and the starting location of the on-demand service may be the shortest distance, the least crowded distance, the optimal distance determined by the processor 220 based on the related historical information and/or real-time road conditions. In some embodiments, all distances between the home locations of the driver terminals of the second driver terminal set and the starting location of the appointment request may be obtained. The driver terminal whose home location is the closest to the starting location of the appointment request of the second driver terminal set may be determined. In some embodiments, there may be at least one driver terminal whose home location is the closest to the starting location of the appointment request of the second driver terminal set. In some embodiments, the home location of the driver terminal may be substituted with a real-time location of the driver terminal, a real-time location of a driver associated with the driver terminal, a common location of the driver terminal, a preset location of the driver terminal, or the like, or any combination thereof. For example, a distance between a preset location of the driver terminal and the starting location of the appointment request may be determined in step 920.

In step 930, if the distance between the home location of the driver terminal and the starting location of the appointment request is the least value of the second driver terminal set, the processor 220 may determine that the driver terminal is a target driver. In some embodiments, there may be at least one driver terminal whose home location is the closest to the starting location of the appointment request of the second driver terminal set. In some embodiments, one of the at least one driver terminal may be determined as the target driver randomly. In some embodiments, one of the at least one driver terminal may be further determined as the target driver based other criteria (e.g., criteria illustrated in FIG. 8 or FIG. 10) described elsewhere in the present disclosure.

In step 940, if the distance between the home location of the driver terminal and the starting location of the appointment request isn't the least value of the second driver terminal set, the processor 220 may determine that the driver terminal is not a target driver terminal.

FIG. 10 is a flowchart of an exemplary process 1000 for determining a target driver based on a second criterion according to some embodiments. In some embodiments, the process 1000 may be implemented in the system 100 illustrated in FIG. 1. For example, the process 1000 may be stored in the database 150 and/or the storage (e.g., the ROM 230, the RAM 240, etc.) as a form of instructions, and called and executed by the server 110 (e.g., the processing engine 112 in the server 110, the CPU 220 of the processing engine 112 in the server 110, or one or more components in the processing engine 112 illustrated in FIG. 3).

In step 1010, the processor 220 may obtain a driver terminal from the second driver terminal set. The second driver terminal set may be stored in the database 150, the ROM 230, the RAM 240, and/or other type of non-transitory storage medium to be executed by the CPU 220. The second driver terminal set may be determined by the processor 220 from the first driver terminal set, and the second driver terminal set may include at least one driver terminal associated with at least one driver that sends a response to accept the appointment invitation in the first driver terminal set. In some embodiments, the driver terminal may include information about an evaluation value, a home location, an amount of successful orders, a historical order, or the like, or any combination thereof. In some embodiments, the processor 220 may loop steps 1010-1040 to obtain other driver terminals to be determined.

In step 1020, the processor 220 may determine whether the amount of successful orders of the driver terminal is the greatest value of the second driver terminal set. In some embodiments, all the amounts of successful orders of the driver terminals of the second driver terminal set may be obtained. The driver terminal with the greatest amount of successful orders in the second driver terminal set may be determined. In some embodiments, there may be at least one driver terminal whose successful orders is the most in the second driver terminal set.

In step 1030, if the amount of successful orders of the driver terminal is the greatest value of the second driver terminal set, the driver terminal may be determined as a target driver. In some embodiments, the second driver terminal set may include at least one driver terminal whose successful orders is the most. In some embodiments, one of the at least one driver terminal may be determined as the target driver randomly. In some embodiments, one of the at least one driver terminal may be further determined as the target driver based other criteria (e.g., criteria illustrated in FIG. 8 or FIG. 9) described elsewhere in the present disclosure.

In step 1040, if the amount of successful orders of the driver terminal isn't the greatest value of the second driver terminal set, the processor 220 may determine that the driver terminal is not a target driver terminal.

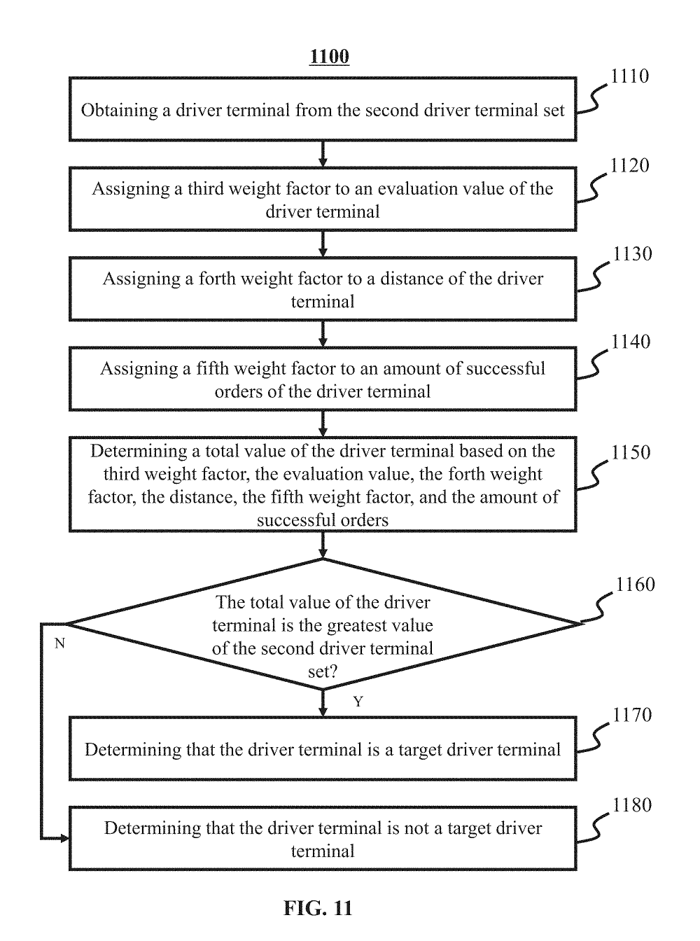

FIG. 11 is a flowchart of an exemplary process 1100 for determining a target driver based on a second criterion according to some embodiments. In some embodiments, the process 1100 may be implemented in the system 100 illustrated in FIG. 1. For example, the process 1100 may be stored in the database 150 and/or the storage (e.g., the ROM 230, the RAM 240, etc.) as a form of instructions, and called and executed by the server 110 (e.g., the processing engine 112 in the server 110, the CPU 220 of the processing engine 112 in the server 110, or one or more components in the processing engine 112 illustrated in FIG. 3).

In step 1110, the processor 220 may obtain a driver terminal from the second driver terminal set. The second driver terminal set may be stored in the database 150, the ROM 230, the RAM 240, and/or other type of non-transitory storage medium to be executed by the CPU 220. The second driver terminal set may be determined by the processor 220 from the first driver terminal set, and the second driver terminal set may include at least one driver terminal associated with at least one driver that sends a response to accept the appointment invitation in the first driver terminal set. In some embodiments, the driver terminal may include information about an evaluation value, a home location, an amount of successful orders, a historical order, or the like, or any combination thereof. In some embodiments, the processor 220 may loop steps 1110-1180 to obtain other driver terminals to be determined.

In step 1120, the processor 220 may assign a third weight factor to an evaluation value of the driver terminal. The third weight factor may be a default value set by the processor 220, or may be determined by the service requester and received by the processor 220. In some embodiments, the third weight factor may be any value within interval 0 to 1. For example, the third weight factor may be 0%, 10%, 25%, 50%, 80%, 100%, etc.

In step 1130, the processor 220 may assign a fourth weight factor to a distance of the driver terminal. The fourth weight factor may be a default value set by the processor 220, or may be determined by the service requester and received by the processor 220. In some embodiments, the fourth weight factor may be any value within interval 0 to 1. For example, the fourth weight factor may be 0%, 10%, 25%, 50%, 80%, 100%, etc.

In step 1140, the processor 220 may assign a fifth weight factor to an amount of successful orders of the driver terminal. The fifth weight factor may be a default value set by the processor 220, or may be determined by the service requester and received by the processor 220. In some embodiments, the fifth weight factor may be any value within interval 0 to 1. For example, the fifth weight factor may be 0%, 10%, 25%, 50%, 80%, 100%, etc. In some embodiments, a sum of the third weight factor, the fourth weight factor, and the fifth weight factor may be 100%. For example, the third weight factor is 0.3, the fourth weight factor is 0.3, and the fifth weight factor is 0.4.

In step 1150, the processor 220 may determine a second total value of the driver terminal based on the third weight factor, the evaluation value, the fourth weight factor, the distance, the fifth weight factor, and the amount of successful orders. In some embodiments, the second total value of the driver terminal may be determined based on the following formula:

T₂=X₃*E+X₄/D+X₅*O (2)

Where T2 represents the second total value of the driver terminal, X3 represents the third weight factor to the evaluation value of the driver terminal, X4 represents the fourth weight factor to the distance of the driver terminal, X5 represents the fifth weight factor to the amount of successful orders of the driver terminal, E represents the evaluation value of the driver terminal, D represents the distance of the driver terminal, and O represents the amount of successful orders of the driver terminal.

In some embodiments, the second total value of the driver terminal may be determined based on the following formula:

T₂=X₃*E/e+X₅*O/o (3)

Where T2 represents the second total value of the driver terminal, X3 represents the third weight factor to the evaluation value of the driver terminal, X5 represents the fifth weight factor to the amount of successful orders of the driver terminal, E represents the evaluation value of the driver terminal, e represents the highest evaluation value in the driver terminal database, O represents the amount of successful orders of the driver terminal, and o represents the upper limit of successful orders in the driver terminal database.

In step 1160, the processor 220 may determine whether the second total value of the driver terminal is the greatest value of the second driver terminal set. In some embodiments, all the second total values of the driver terminals of the second driver terminal set may be obtained. The driver terminal with the greatest second total value in the second driver terminal set may be determined. In some embodiments, the second driver terminal set may include at least one driver terminals whose second total value is the greatest value.

In step 1170, if the second total value of the driver terminal is the greatest value of the second driver terminal set, the processor 220 may determine that the driver terminal is a target driver. In some embodiments, there may be at least one driver terminal whose second total value is the greatest value in the second driver terminal set. In some embodiments, one of the at least one driver terminal may be determined as the target driver randomly. In some embodiments, one of the at least one driver terminal may be further determined as the target driver based other criteria described elsewhere in the present disclosure.

In step 1180, if the second total value of the driver terminal isn't the greatest value of the second driver terminal set, the processor 220 may determine that the driver terminal is not a target driver terminal.

It should be noted that the above description of process 1100 is merely provided for the purposes of illustration, and not intended to be understood as the only embodiment. For persons having ordinary skills in the art, various variations and modifications may be conduct under the teaching of some embodiments of the present disclosure. However, those variations and modifications may not depart from the protecting of some embodiments of the present disclosure. For example, step 1120, 1130 and 1140 may perform in any other sequences.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system configured to allocate appointment orders of an on-demand service, comprising:
a bus;
at least one storage medium in connection with the bus, including a set of instructions for allocating appointment orders in an on-demand service; and
logic circuits in communication with the computer-readable storage medium via the bus, wherein when executing the set of instructions, the logic circuits are directed to execute electronic currents to:
obtain an online appointment request of an on-demand service from a requester;
identify a first service provider terminal set based on a first criterion;
send an appointment invitation of the appointment request to the first service provider terminal set;
obtain at least one response to accept the appointment invitation from a second service provider terminal set in the first service provider terminal set;
identify a target service provider terminal from the second service provider terminal set based on a second criterion;
establish a contractual relationship between the requester and a user of the target service provider terminal; and
send a confirmation notification of the appointment request to the target service provider terminal and the requester.

2. The system of claim 1, wherein the appointment request includes a starting location of the on-demand service and a starting time of the on-demand service; and
the first criterion includes at least one of:
an evaluation value of a service provider terminal is greater than an evaluation threshold, or
a distance between a home location of the user of a service provider terminal and the starting location of the on-demand service is less than a distance threshold.

3. The system of claim 2, wherein to identify the first service provider terminal set, the logic circuits are further directed to:
obtain a plurality of service provider terminals;
for each service provider terminal of the plurality of service provider terminals:
assign a first weight factor to the evaluation value of a service provider terminal;
assign a second weight factor to the distance;
determine a first total value of the provider terminal based on the first weight factor and the second weight factor; and
select, from the plurality service provider terminals, at least one service provider terminal that the corresponding first total value is higher than a total threshold value as the first provider terminal set.

4. The system of claim 1, wherein the appointment request includes a starting location of the on-demand service and a starting time of the on-demand service; and
the second criterion includes at least one of:
an evaluation value of a service provider terminal is the greatest value of the second service provider terminal set,
a distance between a location of the user of a service provider terminal and the starting location of the on-demand service is the least value of the second service provider terminal set, or
an amount of successful orders of a service provider terminal is the greatest value of the second service provider terminal set.

5. The system of claim 4, wherein to identify the target service provider terminal, the logic circuits are further directed to:
for each service provider terminal of the second service provider terminal set:
assign a third weight factor to the evaluation value of a service provider terminal;
assign a fourth weight factor to the distance;
assign a fifth weight factor to the amount of the successful orders;
determine a second total value of the provider terminal based on the third weight factor, the fourth weight factor and the fifth weight factor; and
select, from the second service provider terminal set, a service provider terminal that the corresponding second total value is the highest as the target service provider terminal.

6. The system of claim 1, wherein the appointment request includes a starting location of the on-demand service and a starting time of the on-demand service; and
the logic circuits are further directed to execute electronic currents to:
determine a time period before the starting time of the on-demand service after obtaining the appointment request of the on-demand service from the requester to send out the appointment invitation of the appointment request.

7. The system of claim 1, the logic circuits are further directed to execute electronic currents to:
broadcast the appointment invitation to the first service provider terminal set, or
unicast the appointment invitation to an individual service provider terminal in the first service provider terminal set.

8. A method configured to allocate appointment orders in an on-demand service, comprising:
obtaining, by at least one electronic device, an online appointment request of an on-demand service from a requester;
identifying, by the at least one electronic device, a first service provider terminal set based on a first criterion;
sending, by the at least one electronic device, an appointment invitation of the appointment request to the first service provider terminal set;
obtaining, by the at least one electronic device, at least one response to accept the appointment invitation from a second service provider terminal set in the first service provider terminal set;
identifying, by the at least one electronic device, a target service provider terminal from the second service provider terminal set based on a second criterion;
establishing, by the at least one electronic device, a contractual relationship between the requester and a user of the target service provider terminal; and
sending, by the at least one electronic device, a confirmation notification of the appointment request to the target service provider terminal and the requester.

9. The method of claim 8, wherein the appointment request includes a starting location of the on-demand service and a starting time of the on-demand service; and
the first criterion includes at least one of:
an evaluation value of a service provider terminal is greater than an evaluation threshold, or
a distance between a home location of the user of a service provider terminal and the starting location of the on-demand service is less than a distance threshold.

10. The method of claim 9, wherein the identifying of the first service provider terminal set includes:
obtaining a plurality of service provider terminals;
for each service provider terminal of the plurality of service provider terminals:
assigning a first weight factor to the evaluation value of a service provider terminal;
assigning a second weight factor to the distance;
determining a first total value of the provider terminal based on the first weight factor and the second weight factor; and
selecting, from the plurality service provider terminals, at least one service provider terminal that the corresponding first total value is higher than a threshold value as the first provider terminal set.

11. The method of claim 8, wherein the appointment request includes a starting location of the on-demand service and a starting time of the on-demand service; and
the second criterion includes at least one of:
an evaluation value of a service provider terminal is the greatest value of the second service provider terminal set,
a distance between a location of the user of a service provider terminal and the starting location of the on-demand service is the least value of the second service provider terminal set, or
an amount of successful orders of a service provider terminal is the greatest value of the second service provider terminal set.

12. The method of claim 11, wherein the identifying of the target service provider terminal includes:
for each service provider terminal of the second service provider terminal set:
assigning a third weight factor to the evaluation value of a service provider terminal;
assigning a fourth weight factor to the distance;
assigning a fifth weight factor to the amount of the successful orders;
determining a second total value of the provider terminal based on the third weight factor, the fourth weight factor and the fifth weight factor; and
selecting, from the second service provider terminal set, a service provider terminal that the corresponding second total value is the highest as the target service provider terminal.

13. The method of claim 8, wherein the appointment request includes a starting location of the on-demand service and a starting time of the on-demand service; and
the method further comprising:
determining, by the at least one electronic device, a time period before the starting time of the on-demand service after obtaining the appointment request of the on-demand service from the requester to send out the appointment invitation of the appointment request.

14. The method of claim 8, wherein the sending of the appointment invitation of the appointment request to the first service provider terminal set includes at least one of:
broadcasting the appointment invitation to the first service provider terminal set, or
unicasting the appointment invitation to an individual service provider terminal in the first service provider terminal set.

15. A non-transitory computer readable medium, comprising at least one set of instructions for allocating appointment orders in an on-demand service, wherein when executed by logic circuits of an electronic device, the at least one set of instructions directs the logic circuits to perform acts of:
obtaining an online appointment request of an on-demand service from a requester;
identifying a first service provider terminal set based on a first criterion;
sending an appointment invitation of the appointment request to the first service provider terminal set;
obtaining at least one response to accept the appointment invitation from a second service provider terminal set in the first service provider terminal set;
identifying a target service provider terminal from the second service provider terminal set based on a second criterion;
establishing a contractual relationship between the requester and a user of the target service provider terminal; and
sending a confirmation notification of the appointment request to the target service provider terminal and the requester.

16. The non-transitory computer readable medium of claim 15, wherein the appointment request includes a starting location of the on-demand service and a starting time of the on-demand service; and
the first criterion includes at least one of:
an evaluation value of a service provider terminal is greater than an evaluation threshold, or
a distance between a home location of the user of a service provider terminal and the starting location of the on-demand service is less than a distance threshold.

17. The non-transitory computer readable medium of claim 16, wherein the identifying of the first service provider terminal set includes:
obtaining a plurality of service provider terminals;
for each service provider terminal of the plurality of service provider terminals:
assigning a first weight factor to the evaluation value of a service provider terminal;
assigning a second weight factor to the distance;
determining a first total value of the provider terminal based on a the first weight factor and the second weight factor; and
selecting, from the plurality service provider terminals, at least one service provider terminal that the corresponding first total value is higher than a threshold value as the first provider terminal set.

18. The non-transitory computer readable medium of claim 15, wherein the appointment request includes a starting location of the on-demand service and a starting time of the on-demand service; and
the second criterion includes at least one of:
an evaluation value of a service provider terminal is the greatest value of the second service provider terminal set,
a distance between a location of the user of a service provider terminal and the starting location of the on-demand service is the least value of the second service provider terminal set, or
an amount of successful orders of a service provider terminal is the greatest value of the second service provider terminal set.

19. The non-transitory computer readable medium of claim 18, wherein the identifying of the target service provider terminal includes:
for each service provider terminal of the second service provider terminal set:
assigning a third weight factor to the evaluation value of a service provider terminal;
assigning a fourth weight factor to the distance;
assigning a fifth weight factor to the amount of the successful orders;
determining a second total value of the provider terminal based on the third weight factor, the fourth weight factor and the fifth weight factor; and
selecting, from the second service provider terminal set, a service provider terminal that the corresponding second total value is the highest as the target service provider terminal.

20. The non-transitory computer readable medium of claim 15, wherein the appointment request includes a starting location of the on-demand service and a starting time of the on-demand service; and
the at least one set of instructions further directs the logic circuits to perform acts of:
determining a time period before the starting time of the on-demand service after obtaining the appointment request of the on-demand service from the requester to send out the appointment invitation of the appointment request.
